(19) United States
(12) Patent Application Publication
(10) Pub. No.: US 2017/0096980 A1
(43) Pub. Date: Apr. 6, 2017

(54) APPARATUS AND METHOD FOR CONTROLLING GLOW PLUG OF DIESEL HYBRID VEHICLE

(71) Applicant: Hyundai Motor Company, Seoul (KR)

(72) Inventor: Hwa Yong Jang, Hwaseong (KR)

(21) Appl. No.: 14/960,428

(22) Filed: Dec. 6, 2015

(30) Foreign Application Priority Data
Oct. 6, 2015 (KR) 10-2015-0140089

(51) Int. Cl. F02P 19/02; F02N 11/08

(52) U.S. Cl. CPC F02P 19/026; F02P 19/021; F02N 11/0814

(57) ABSTRACT

An apparatus and method for controlling a glow plug of a diesel hybrid vehicle in which an engine is frequently turned on/off. The apparatus and method are capable of assisting running torque required for motion of the diesel hybrid vehicle through a torque aid operation of a hybrid motor in order to enable pre-heating of an engine combustion chamber in an initial stage of an engine running mode, using an inexpensive glow plug.

### CROSS-REFERENCE TO RELATED APPLICATION

This application claims under 35 U.S.C. §119(a) the benefit of Korean Patent Application No. 10-2015-0140089 filed on Oct. 6, 2015, the entire contents of which are incorporated herein by reference.

### BACKGROUND

(a) Technical Field

The present invention relates to an apparatus and method for controlling a glow plug of a diesel hybrid vehicle involving in which an engine is frequently turned on/off.

(b) Description of the Related Art

Generally, a diesel engine, which is an internal combustion engine using diesel (light oil) as a fuel, is driven through a compression ignition system to compress air sucked into a cylinder (combustion chamber) into a high-temperature and high-pressure state. In the compression procedure, a fuel is injected into the high-temperature and high-pressure atmosphere heated to several hundred degrees Celsius and, as such, combustion is generated through self-ignition.

However, when the above-mentioned ignition procedure does not satisfy a required high-temperature condition, initial ignition stability is degraded. In this case, delay of ignition occurs until a required high-temperature condition is satisfied.

Recently, for improvement of initial ignition stability, execution of a function for igniting a fuel in a pre-combustion chamber for flames spreading easily to a fuel in a combustion chamber has been proposed. For execution of such a function, a start auxiliary device, known as a “glow plug,” has been applied to a diesel engine.

That is, for ensuring start of the diesel engine, the glow plug heats air in an engine cylinder to a high temperature. Accordingly, the glow plug is a start auxiliary device required under low-temperature conditions in a diesel engine in which fuel and air in a cylinder are ignited in a compressed state.

In the case of a pencil type glow plug, enhanced initial ignition is achieved because electrical energy is converted into heat by the glow plug.

In general, glow plugs are classified as an inexpensive type glow plug using a metal material and an expensive type glow plug using a ceramic material. The expensive type glow plug has advantages in that high-temperature control can be achieved, and post heat time is long, as compared to the inexpensive type glow plug.

Meanwhile, in a general diesel engine vehicle, the glow plug thereof is used only in an initial start stage because the engine of the vehicle is continuously operated after being started.

Similarly, in the case of a diesel engine vehicle, to which an idle stop and go (ISG) system is applied, the glow plug thereof is used only in an initial start stage because idle stop is executed only when temperature of the engine is equal to or higher than a predetermined temperature.

On the other hand, in a hybrid vehicle equipped with a diesel engine (namely, a diesel hybrid vehicle), frequent engine on/off occurs in addition to driving of an electric motor. For this reason, a glow plug should be used whenever cylinder temperature is low upon starting of an engine. In this regard, it is necessary to develop a glow plug control technology for diesel hybrid vehicles.

Korean Unexamined Patent Publication No. 2006-0023616 (Mar. 15, 2006) discloses glow plug control technology associated with a general engine vehicle and, as such, is unsuitable for use in a diesel hybrid vehicle in which frequent engine on/off occurs during traveling.

### SUMMARY

The present invention relates to an apparatus and method for controlling a glow plug of a diesel hybrid vehicle, capable of assisting running torque required for motion of the diesel hybrid vehicle through a torque aid operation of a hybrid motor in order to enable pre-heating of an engine combustion chamber in an initial stage of an engine running mode, using an inexpensive glow plug.

In one aspect, the present invention provides an apparatus for controlling a glow plug of a diesel hybrid vehicle, including an engine control unit for requesting a hybrid control unit to drive a hybrid motor when it is determined that operation of the glow plug for pre-heating of a combustion chamber in a diesel engine is required in an initial stage of an engine running mode after a mode change has occurred in the diesel hybrid vehicle, and the hybrid control unit for driving the hybrid motor at the request of the engine control unit, to assist running torque required for travel of the diesel hybrid vehicle.

In a preferred embodiment, the engine control unit may operate the glow plug when recognizing driving of the hybrid motor through the hybrid control unit.

In another preferred embodiment, the engine control unit may inject a fuel into the combustion chamber of the diesel engine when recognizing completion of the driving of the hybrid motor to assist running torque through the hybrid control unit.

In still another preferred embodiment, the engine control unit may determine that the operation of the glow plug is required, when an engine cooling water temperature and a battery voltage in an ignition-on state satisfy predetermined conditions.

In yet another preferred embodiment, the engine control unit may determine whether or not the operation of the glow plug is required in the initial stage of the engine running mode when recognizing that a running mode is changed from the hybrid running mode to the engine running mode through the hybrid control unit, and may operate the glow plug when it is determined that the operation of the glow plug is required.

In still yet another preferred embodiment, the engine control unit may send, to the hybrid control unit, a signal for recognition of completion of the glow plug operation when the operation of the glow plug is completed, and, in response to the signal sent from the engine control unit, the hybrid control unit may complete the driving of the hybrid motor.

In another aspect, the present invention provides a method for controlling a glow plug of a diesel hybrid vehicle, including determining whether or not operation of the glow plug for pre-heating of a combustion chamber in a diesel engine is required in an initial stage of an engine running mode after a mode change has occurred in the diesel hybrid vehicle, and operating the glow plug when the operation of the glow plug is required, and requesting a torque aid operation of a hybrid motor to assist running torque of the vehicle during the operation of the glow plug.

A non-transitory computer readable medium containing program instructions executed by a processor, the computer readable medium can include: program instructions that determine whether or not operation of a glow plug for pre-heating of a combustion chamber in a diesel engine is required in an initial stage of an engine running mode after a mode change has occurred in a diesel hybrid vehicle; and program instructions that operate the glow plug when the operation of the glow plug is required, and requesting a torque aid operation of a hybrid motor to assist running torque of the diesel hybrid vehicle during the operation of the glow plug.

In a preferred embodiment, the torque aid operation of the hybrid motor may be completed when the operation of the glow plug is completed.

Other aspects and preferred embodiments of the invention are discussed infra.

In accordance with the present invention, a hybrid motor in a diesel hybrid vehicle is driven under control of a hybrid control unit in an initial stage of an engine running mode in which operation of a glow plug is required, to generate torque corresponding to a portion of running torque required in a diesel engine, thereby assisting running torque and, as such, the running torque required for motion of the vehicle may not completely depend on fuel injection.

In accordance with the present invention, as the glow plug, which functions to increase combustion chamber temperature in the initial stage of the engine running mode, an expensive glow plug made of a ceramic material is not used although controlling a rapid increase in temperature is possible without torque assist of a hybrid motor. Instead, an inexpensive glow plug made of a metal material is used. Although the metal glow plug takes a long time to increase combustion chamber temperature, compared with that of the expensive ceramic glow plug, it may be possible to secure combustion stability while achieving cost reduction.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 (RELATED ART) is a block diagram illustrating conventional glow plug control conditions for a diesel engine;

FIG. 2 is a block diagram illustrating running modes according to motion of a diesel hybrid vehicle;

FIG. 3 is a block diagram illustrating a method for controlling a glow plug of a diesel hybrid vehicle and control conditions thereof in accordance with the present invention; and

FIG. 4 is a flowchart illustrating the glow plug control method according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

First, a conventional glow plug control method for a diesel engine will be described.

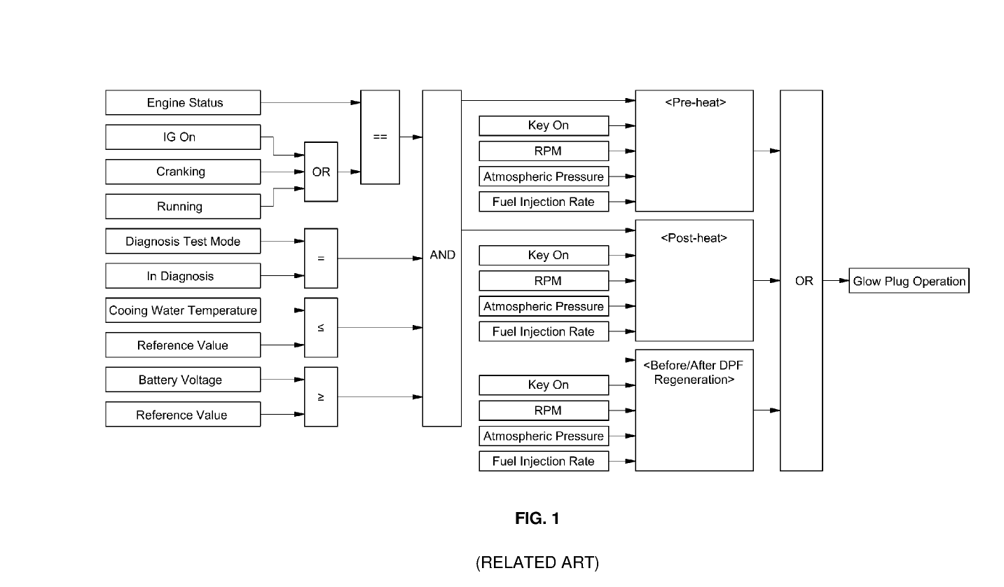

FIG. 1 (RELATED ART) illustrates conventional glow plug control conditions for a diesel engine.

As illustrated in FIG. 1, when the diesel engine is in an ignition-on (IG-On) state, in a cranking state or in a running state, it is determined whether or not a glow plug should operate, in accordance with cooling water temperature and battery voltage. In this case, the glow plug is determined to operate in three periods, namely, a pre-heat period, a post-heat period and a period before/after diesel particle filter (DPF) regeneration.

In the pre-heat period, the glow plug operates to secure idle stability after increase of combustion chamber temperature in an initial stage of start in the IG-On state of the diesel engine. In the post-heat period, the glow plug also operates because, in the post-heat period, the vehicle moves under coasting conditions during travel on a road such as a steel plate road in an engine running state and, as such, combustion chamber temperature is lowered. In the period before/after DPF regeneration, the glow plug also operates to secure efficient regeneration temperature during DPF generation.

However, the above-described glow plug control technology is a technology developed for application to a diesel engine vehicle in which the glow plug thereof is used only for initial start. A new glow plug technology is needed for a diesel hybrid vehicle in which the glow plug thereof should be used whenever cylinder temperature is lowered below a desired temperature due to frequent engine on/off.

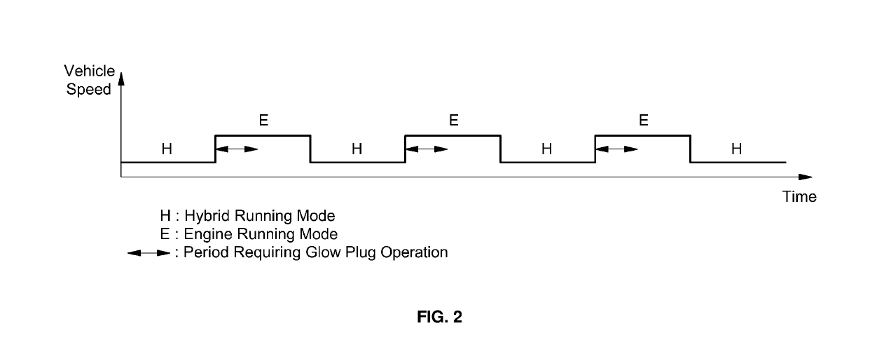

Meanwhile, as illustrated in FIG. 2, the diesel hybrid vehicle, which is equipped with a diesel engine, moves mainly in a hybrid running mode in which the vehicle moves/travels using torque (drive power) from a hybrid motor and in an engine running mode in which the vehicle moves/travels using torque (drive power) from the diesel engine. Due to a mode change between the hybrid running mode and the engine running mode, the diesel engine is frequently turned on/off and, as such, the glow plug should operate upon engine start whenever cylinder temperature is lowered below a desired temperature. When a running mode is changed from the hybrid running mode to the engine running mode, the glow plug should operate in an initial stage of the engine running mode in order to increase cylinder temperature of the engine.

In the present invention, the hybrid motor operates for a time required for operation of the glow plug in the initial stage of the engine running mode after a mode change has occurred in the hybrid vehicle, to assist running torque of a vehicle (motion torque) required for the diesel engine.

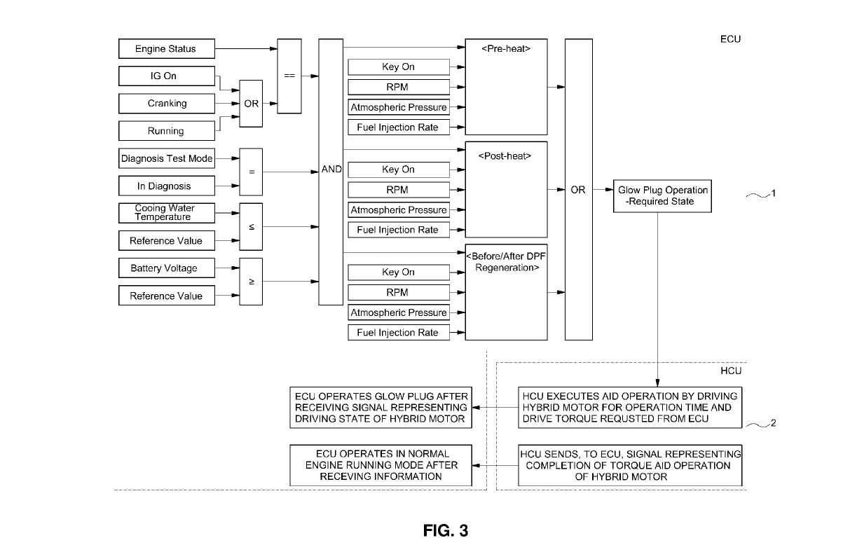

Referring to FIG. 3, an apparatus for controlling a glow plug of a diesel hybrid vehicle in accordance with the present invention is illustrated. The glow plug control apparatus includes an engine control unit (ECU) 1, and a hybrid control unit (HCU) 2, which is superordinate to the ECU 1.

The ECU 1 determines whether or not operation of a glow plug for pre-heating of a combustion chamber in a diesel engine is required when the diesel engine starts in order to run the vehicle in an engine running mode.

In the diesel hybrid vehicle, an ignition-on state is maintained in a hybrid running mode. Accordingly, even in an initial stage after the hybrid running mode is changed to the engine running mode, the ignition-on state is still maintained. In this connection, the ECU 1 determines whether or not operation of the glow plug is required, based on information about engine cooling water temperature and battery voltage in the ignition-on state.

In detail, when the engine cooling water temperature in the ignition-on state is equal to or lower than a predetermined reference temperature, and the battery voltage in the ignition-on state is equal to or higher than a predetermined reference voltage, the ECU 1 determines that operation of the glow plug is required.

When it is determined that operation of the glow plug is required, the ECU 1 sends a signal requesting operation of the hybrid motor to the HCU 2.

At the request of the ECU 1, the HCU 2 then drives the hybrid motor. In this case, the HCU 2 checks a required operation time and a required drive torque, based on information received from the ECU 1, and drives the hybrid motor in accordance with the required operation time and drive torque, to assist running torque (motion torque) required for travel of the vehicle.

That is, the HCU 2 drives the hybrid motor in an initial stage of the engine running mode for a predetermined time without turning off the hybrid motor immediately after a mode change to the engine running mode, at the request of the ECU 1.

Subsequently, the ECU 1 receives a signal from the HCU 2, and recognizes that the hybrid motor is in an ON state, through checking of the received signal. Then, the ECU 1 operates the glow plug, to increase combustion chamber temperature.

For a period in which combustion chamber temperature is increased to a desired high temperature in accordance with operation of the glow plug, ignition of the diesel engine is delayed. During this period, the hybrid motor operates to assist running torque (motion torque) of the vehicle, as such, the torque required for motion of the vehicle (running torque) may be generated without relying on fuel injection.

When the aid operation of the hybrid motor to assist running torque is completed, the HCU 2 sends a signal representing completion of the aid operation to the ECU 1 which, in turn, recognizes completion of motor driving.

The aid operation of the hybrid motor is completed at a time when pre-heating operation of the glow plug is completed and, as such, normal driving of the engine is possible after completion of the torque aid operation of the hybrid motor.

Accordingly, the ECU 1 controls the vehicle to move in a normal engine running mode after receiving a signal representing completion of operation of the hybrid motor to assist running torque.

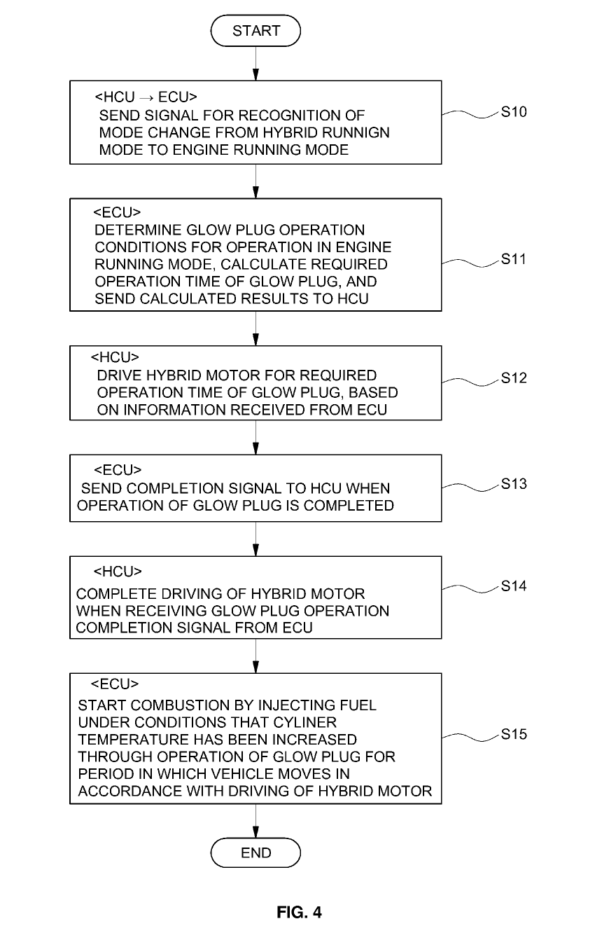

Hereinafter, the method for controlling the glow plug of the diesel hybrid vehicle through the above-described configuration in accordance with the present invention will be described in more detail with reference to FIG. 4.

Generally, operation of the glow plug is not required under low or middle speed conditions that the vehicle moves by the hybrid motor, but required in an initial stage after a mode change to the engine running mode in which the vehicle moves by the engine (see FIG. 2).

Accordingly, after the mode change from the hybrid running mode to the engine running mode, combustion chamber temperature of the engine is increased through operation of the glow plug in an initial stage of the engine running mode, and fuel is then injected and, as such, combustion stability may be enhanced.

Generally, use of a glow plug made of a ceramic material having a function capable of achieving rapid temperature increase is advantageous in that combustion stability can be achieved. However, such a ceramic glow plug is expensive.

In the present invention, a glow plug made of an inexpensive metal material preferably is used. Although the inexpensive glow plug takes a long time to increase combustion chamber temperature, compared with the expensive ceramic glow plug, it may be possible to secure combustion stability while achieving cost reduction.

As illustrated in FIG. 4, in accordance with the glow plug control method, when a mode change from the hybrid running mode to the engine running mode occurs, the HCU sends a signal for recognition of the mode change to the ECU (S10).

The ECU checks operation conditions of the glow plug for motion of the vehicle in the engine running mode, namely, conditions associated with engine cooling water temperature, battery voltage, etc., to determine whether or not operation of the glow plug is required. When it is determined, based on the checked results, that operation of the glow plug is required, the ECU calculates a required operation time of the glow plug for pre-heating of the combustion chamber of the engine. Thereafter, the ECU operates the glow plug for the calculated required operation time. At the same time, the ECU requests that the HCU control the hybrid motor to perform a torque aid operation for the calculated required operation time (S11).

At this time, the ECU also determines a required drive torque of the hybrid motor, and sends information about the determined required running torque to the HCU.

Then, in accordance with the signal (information) received from the ECU, the HCU drives the hybrid motor for a predetermined time in the initial stage of the engine running mode, to assist running torque (S12).

In this case, the HCU determines motion conditions of the vehicle, and drives the hybrid motor for the required operation time of the glow plug.

Subsequently, when the pre-heating operation of the glow plug is completed, the ECU sends, to the HCU, a signal representing completion of operation of the glow plug (S13). In response to the signal sent from the ECU, the HCU completes the torque aid operation of the hybrid motor (S14).

Alternatively, the ECU previously estimates a time, at which the pre-heating operation of the glow plug will be completed before completion of operation of the glow plug, and sends information about the estimated time to the HCU through real-time communication. In response to the signal sent from the ECU, the HCU completes operation of the hybrid motor when the estimated time passes.

Subsequently, the ECU injects fuel into the cylinder of the engine, to start combustion, under conditions that an engine cylinder temperature has been increased through operation of the glow plug carried out for a period in which the hybrid motor is driven to assist running torque required for motion of the vehicle in the initial stage of the engine running mode that has been changed from the hybrid running mode, and controls the vehicle to move in the normal engine running mode (S15).

As apparent from the above description, in accordance with the present invention, a hybrid motor in a diesel hybrid vehicle is driven under control of an HCU in an initial stage of an engine running mode in which operation of a glow plug is required, to generate torque corresponding to a portion of running torque required in a diesel engine, thereby assisting running torque and, as such, the running torque required for motion of the vehicle may be generated without completely relying on fuel injection.

The glow plug, which functions to increase combustion chamber temperature in the initial stage of the engine running mode, can be made of an inexpensive metal material, instead of an expensive glow plug made of a ceramic material, and thus controlling a rapid increase in temperature is possible without torque assist of a hybrid motor. Although the metal glow plug made of the inexpensive metal material, according to the present invention, takes a long time to increase combustion chamber temperature, compared with the expensive ceramic glow plug, it may be possible to secure combustion stability while achieving cost reduction.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for controlling a glow plug of a diesel hybrid vehicle, comprising:
an engine control unit for requesting a hybrid control unit to drive a hybrid motor when it is determined that operation of the glow plug for pre-heating of a combustion chamber in a diesel engine is required in an initial stage of an engine running mode after a mode change has occurred in the diesel hybrid vehicle; and
a hybrid control unit for driving the hybrid motor at the request of the engine control unit, to assist running torque required for travel of the diesel hybrid vehicle.

2. The apparatus of claim 1, wherein the engine control unit operates the glow plug when recognizing driving of the hybrid motor through the hybrid control unit.

3. The apparatus of claim 1, wherein the engine control unit injects a fuel into the combustion chamber of the diesel engine when recognizing completion of the driving of the hybrid motor to assist running torque through the hybrid control unit.

4. The apparatus of claim 1, wherein the engine control unit determines that the operation of the glow plug is required, when an engine cooling water temperature and a battery voltage in an ignition-on state satisfy predetermined conditions.

5. The apparatus of claim 1, wherein the engine control unit determines whether or not the operation of the glow plug is required in the initial stage of the engine running mode when recognizing that a running mode is changed from a hybrid running mode to the engine running mode through the hybrid control unit, and operates the glow plug when it is determined that the operation of the glow plug is required.

6. The apparatus of claim 5, wherein the engine control unit sends, to the hybrid control unit, a signal for recognition of completion of the glow plug operation when the operation of the glow plug is completed, and, in response to the signal sent from the engine control unit, the hybrid control unit completes the driving of the hybrid motor.

7. A method for controlling a glow plug of a diesel hybrid vehicle, comprising:
determining whether or not operation of the glow plug for pre-heating of a combustion chamber in a diesel engine is required in an initial stage of an engine running mode after a mode change has occurred in the diesel hybrid vehicle; and
operating the glow plug when the operation of the glow plug is required, and requesting a torque aid operation of a hybrid motor to assist running torque of the diesel hybrid vehicle during the operation of the glow plug.

8. The method of claim 7, wherein, in the operating and requesting, the torque aid operation of the hybrid motor is completed when the operation of the glow plug is completed.

9. A non-transitory computer readable medium containing program instructions executed by a processor, the computer readable medium comprising:
program instructions that determine whether or not operation of a glow plug for pre-heating of a combustion chamber in a diesel engine is required in an initial stage of an engine running mode after a mode change has occurred in a diesel hybrid vehicle; and
program instructions that operate the glow plug when the operation of the glow plug is required, and requesting a torque aid operation of a hybrid motor to assist running torque of the diesel hybrid vehicle during the operation of the glow plug.
